(19) United States
(12) Patent Application Publication
(10) Pub. No.: US 2026/0336703 A1
(43) Pub. Date: Oct. 29, 2026

(54) CAR BODY FOR VEHICLE

(71) Applicant: Hyundai Steel Company, Incheon (KR)

(72) Inventors: Chi Sung Jeon, Incheon (KR); Dong Yul Lee, Incheon (KR); Dong Hyun Kim, Incheon (KR)

(73) Assignee: Hyundai Steel Company, Incheon (KR)

(21) Appl. No.: 19/718,110

(22) Filed: Jun. 24, 2026

Related U.S. Application Data
(63) Continuation of application No. PCT/KR2024/021039, filed on Dec. 24, 2024.

(30) Foreign Application Priority Data
Dec. 29, 2023 (KR) 1020230197460

(51) Int. Cl. B62D 21/02; B60K 1/04

(52) U.S. Cl. CPC B62D 21/02; B60K 1/04; B60K 2001/0438

(57) ABSTRACT

Provided is a vehicle body including a battery case on an underside of a vehicle, a first front side member arranged on a front portion of the vehicle and extending in a longitudinal direction of the vehicle, a second front side member spaced apart from the first front side member in a transverse direction of the vehicle and extending in the longitudinal direction of the vehicle, and a rear cross member connecting the first front side member to the second front side member and extending in the transverse direction of the vehicle, in which the rear cross member is provided to overlap a front portion of the battery case.

### CROSS-REFERENCE TO RELATED APPLICATIONS

This application is a continuation of International Application No. PCT/KR2024/021039 filed Dec. 24, 2024, which claims the benefit of Korean Patent Application No. 10-2023-0197460, filed Dec. 29, 2023, in the Korean Intellectual Property Office, the entire contents of all of which applications are incorporated herein by reference.

### FIELD

Embodiments of the present disclosure relate to a vehicle subframe and a vehicle body.

### BACKGROUND

With the electrification of vehicles, the adoption of electric vehicles using electric motors as their power source instead of internal combustion engines is on the rise.

To increase their driving range (the distance that may be traveled on a full charge), the electric vehicles need to be equipped with high-capacity batteries. Typically, in electric vehicles, the underside of the vehicle may be used as a space to mount the battery thereon. The battery may be mounted over a large area on the underside of the vehicle to increase the capacity of the battery, thereby extending the driving range.

As the battery is mounted on the underside of the vehicle, research is actively underway on deformation of the vehicle body and the chassis at the front of the vehicle in the event of a frontal collision, an offset collision, or a small-overlap collision, and safety measures also have to be taken to protect against impacts from protruding obstacles, such as speed bumps and uneven road surfaces.

### SUMMARY

In one aspect, embodiments of the present disclosure provide a vehicle body.

According to an aspect of the present disclosure, a vehicle body includes a battery case on an underside of a vehicle, a first front side member arranged on a front portion of the vehicle and extending in a longitudinal direction of the vehicle, a second front side member spaced apart from the first front side member in a transverse direction of the vehicle and extending in the longitudinal direction of the vehicle, and a rear cross member connecting the first front side member to the second front side member and extending in the transverse direction of the vehicle, in which the rear cross member is provided to overlap a front portion of the battery case.

According to an embodiment, the rear cross member suitably may cover the front portion of the battery case when viewed from a front side of the vehicle.

According to an embodiment, the rear cross member suitably may be arranged further toward a lower side of the vehicle than the battery case.

According to an embodiment, the rear cross member suitably may be provided in a straight shape, or substantially straight shape.

According to an embodiment, at least a portion of the rear cross member suitably may be provided in a curved shape that is convex toward a front side of the vehicle. For example, the first cross member may comprise a convex curved shape whose longitudinal axis forms an arc of a circle toward the front of the vehicle.

In additional aspects, a vehicle body system is provided that comprises a vehicle body as disclosed herein and an associated vehicle battery (such as a battery of an electric-powered vehicle). The battery may be contained with and/or within the vehicle as disclosed herein.

In further aspects, a vehicle is provided that comprises a vehicle body as disclosed herein. A battery may be associated with the vehicle and vehicle body. In aspects, an electric-powered vehicle (electric vehicle) is provided that comprises a vehicle body as disclosed herein. A battery may be associated with the vehicle body.

As referred to herein, tensile strength (TS) can be measured using a commercially available device such as a commercially available tensile tester and according to the ISO standard ISO 6892-1, published in October 2009.

According to an embodiment of the present disclosure as described above, it is possible to implement a vehicle body for protecting a battery of an electric vehicle. However, the scope of the present disclosure is not limited by these effects.

### BRIEF DESCRIPTION OF DRAWINGS

FIG. 1 shows a side view and a plan view schematically showing a vehicle.

FIG. 2A is a perspective view schematically showing a front body structure and a vehicle subframe of a vehicle.

FIG. 2B is a side view schematically showing a front body structure and a vehicle subframe of the vehicle, viewed from a side.

FIG. 2C is a plan view schematically showing a front body structure and a vehicle subframe of the vehicle, viewed from the front.

FIGS. 3 and 4 are perspective views schematically showing a rear cross member and a battery case, according to embodiments.

### DETAILED DESCRIPTION

The present disclosure may undergo various modifications and have various embodiments, and specific embodiments are illustrated in the drawings and described in detail in the detailed description. The effects and features of the present disclosure and the method for achieving them will become clear with reference to the embodiments described in detail below together with the drawings. However, the present disclosure is not limited to the embodiments disclosed below and may be implemented in various forms.

Hereinafter, embodiments of the present disclosure will be described in detail with reference to the accompanying drawings. In the drawings, identical or corresponding components are given the same reference numerals, and redundant descriptions thereof will be omitted.

In the embodiments below, the terms “first,” “second,” etc. are not used in a limiting sense but are used to distinguish one component from another.

In the embodiments below, an expression used in the singular encompasses the expression of the plural unless it has a clearly different meaning in the context.

In the embodiments below, the terms such as “including” and “having” are intended to indicate the existence of features or components disclosed in the specification and are not intended to preclude the possibility that at least one other features or components may be added.

In the following embodiments, when a portion, such as a film, a region, a component, etc., is present on or above another portion, this case may include not only a case where it is directly on the other portion, but also a case where another film, region, component, etc., is arranged between the portion and the other portion.

In the drawings, the sizes of components may be exaggerated or reduced for convenience of description. For example, the sizes and thicknesses of each component in the drawings are arbitrarily illustrated for convenience of description, and therefore, the present disclosure is not necessarily limited to the drawings.

When it is possible to modify an embodiment, the order of processes may be different from the order in which the processes have been described. For example, two processes described as being performed sequentially may be substantially performed simultaneously or in a reverse order.

Herein, “A and/or B” may indicate A, B, or both A and B. “at least one of A and B” may indicate A, B, or both A and B.

In the following embodiments, when a film, a region, a component, etc., are connected, the case may include a case where they are directly connected, and/or a case where they are indirectly connected, having another film, region, and component therebetween. For example, herein, when a film, a region, a component, etc., are electrically connected, the case may include a case where they are directly electrically connected, and/or a case where they are indirectly electrically connected, having another film, region, and component therebetween.

An x-axis, a y-axis, and a z-axis are not limited to three axes on an orthogonal coordinate system, and may be interpreted in a broad sense including them. For example, the x-axis, y-axis, and z-axis may be orthogonal to one another or may indicate different directions that are not orthogonal to each other.

It is understood that the term “vehicle” or “vehicular” or other similar term as used herein is inclusive of motor vehicles in general such as passenger automobiles including sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In particular aspects, a vehicle as referred to herein includes an electric-powered vehicle.

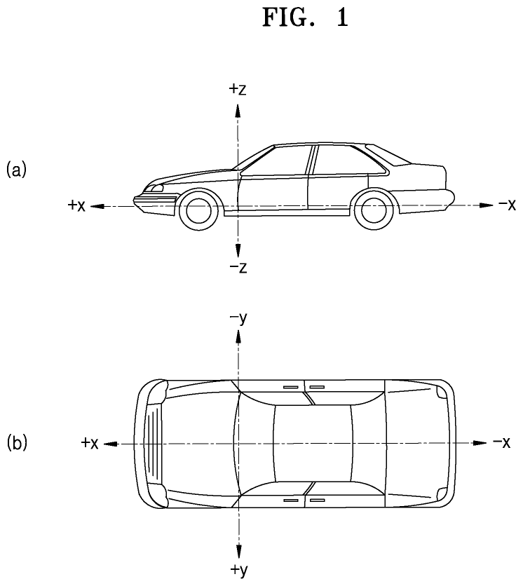

FIG. 1 shows a side view and a plan view schematically showing a vehicle. Specifically, (a) of FIG. 1 is a side view schematically showing the vehicle viewed from a side, and (b) of FIG. 1 is a plan view schematically showing the vehicle viewed from above. FIG. 1 is a side view and a plan view schematically showing the vehicle to specifically illustrate a longitudinal direction, a transverse direction, and a vertical direction of the vehicle.

Referring to (a) of FIG. 1, the longitudinal direction of the vehicle may be an x-direction. The vertical direction of the vehicle may be a z-direction. The vertical direction of the vehicle (e.g., the z-direction) may intersect the longitudinal direction of the vehicle (e.g., the x-direction) as shown in the side view.

Referring to (b) of FIG. 1, the longitudinal direction of the vehicle may be the x-direction. The transverse direction of the vehicle may be a y-direction. The transverse direction of the vehicle (e.g., the y-direction) may intersect the longitudinal direction of the vehicle (e.g., the x-direction). Although not shown, the vertical direction (e.g., the z-direction) of the vehicle may intersect the transverse direction (e.g., the y-direction) of the vehicle.

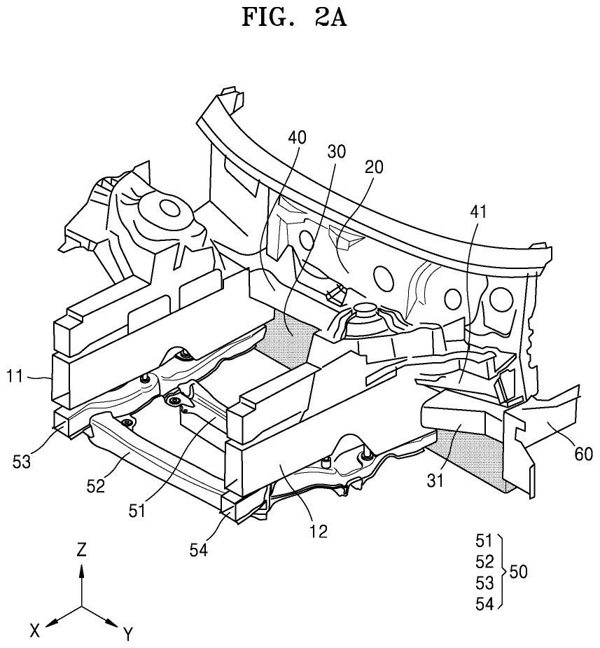

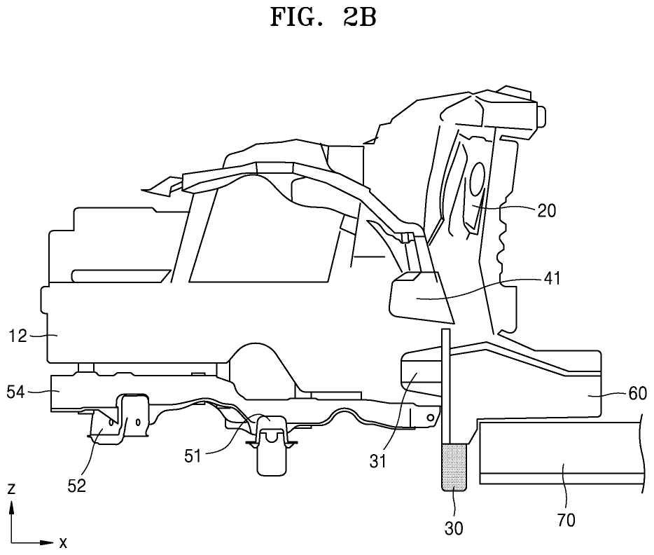

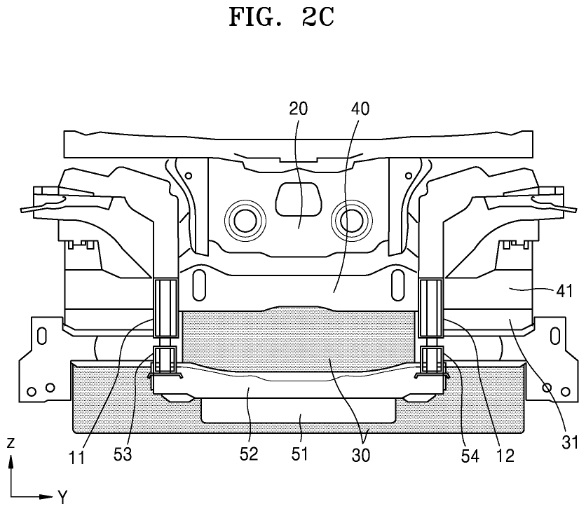

FIG. 2A is a perspective view schematically showing a front body structure and a vehicle subframe of a vehicle. FIG. 2B is a side view schematically showing a front body structure and a vehicle subframe of the vehicle, viewed from a side. FIG. 2C is a plan view schematically showing a front body structure and a vehicle subframe of the vehicle, viewed from the front.

Referring to FIGS. 2A, 2B, and 2C, the front body structure of the vehicle may include a first front side member 11, a second front side member 12, a rear cross member 30, a rear cross member side 31, a dash cross member 40, a dash cross member side 41, a dash panel 20, and a side sill inner front extension 60. The first front side member 11 and the second front side member 12 may be arranged to extend in the longitudinal direction (e.g., the x-direction) of the vehicle. The first front side member 11 and the second front side member 12 may be spaced apart from each other in the transverse direction (e.g., the y-direction) of the vehicle.

The rear cross member 30 may be connected to the first front side member 11 and the second front side member 12, and may extend in the transverse direction (e.g., the y-direction) of the vehicle.

The rear cross member 30 may include rear cross member sides 31 arranged on opposite sides thereof. In other words, the rear cross member 30 may include the rear cross member sides 31 arranged on the left and right sides of the vehicle. The first front side member 11 and the second front side member 12 may be connected to the rear cross member 30 and the rear cross member sides 31, and the first front side member 11 and the second front side member 12 may be connected to the side sill inner front extension 60 through the rear cross member sides 31.

The side sill inner front extension 60 may extend along the left and right sides of the vehicle in the longitudinal direction (e.g., the x-direction) of the vehicle. The side sill inner front extension 60 may be connected to the first front side member 11 and the second front side member 12 via the rear cross member sides 31. Although not shown, a side sill may be arranged on an outer side of the side sill inner front extension 60. A battery case 70 may be arranged below the side sill inner front extension 60.

A dash panel 20 may be arranged behind the first front side member 11 and the second front side member 12. In other words, the dash panel 20 may be arranged on the rear cross member 30 and the dash cross member 40. The length of the dash panel 20 may extend in the transverse direction (e.g., the y-direction) of the vehicle, and the height of the dash panel 20 may extend in the vertical direction (e.g., the z-direction) of the vehicle. The dash panel 20 may separate the front body structure of the vehicle from a passenger compartment of the vehicle. The front body structure of the vehicle may accommodate a powertrain that includes an electric motor or an internal combustion engine. The dash cross member 40 may be attached to the front of the dash panel 20.

The dash cross member 40 may be arranged under the dash panel 20. The dash cross member 40 may extend in the transverse direction of the vehicle (for example, the y-direction). The dash cross member 40 may be connected to the dash panel 20.

The dash cross member sides 41 may be arranged on opposite sides of the dash cross member 40. In other words, the dash cross member sides 41 may be arranged on the left and right sides of the vehicle. The dash cross member sides 41 may be connected to the dash panel 20 and the dash cross member 40. The dash cross member sides 41 may be connected to the first front side member 11 and the second front side member 12.

In an embodiment, the vehicle subframe 50 may be arranged under the first front side member 11 and the second front side member 12. The vehicle subframe 50 may include a first side member 53 and a second side member 54 extending in the longitudinal direction (e.g., the x-direction) of the vehicle. The first side member 53 and the second side member 54 may be spaced apart from each other in the transverse direction (e.g., the y-direction) of the vehicle.

The vehicle subframe 50 may include a first cross member 51 and a second cross member 52 extending in the transverse direction (e.g., the y-direction) of the vehicle. The first cross member 51 and the second cross member 52 may be spaced apart from each other in the longitudinal direction (e.g., the x-direction) of the vehicle.

The first cross member 51 may be connected to the first side member 53 and the second side member 54. Likewise, the second cross member 52 may be connected to the first side member 53 and the second side member 54. The second cross member 52 may be arranged closer to a front side of the vehicle than the first cross member 51.

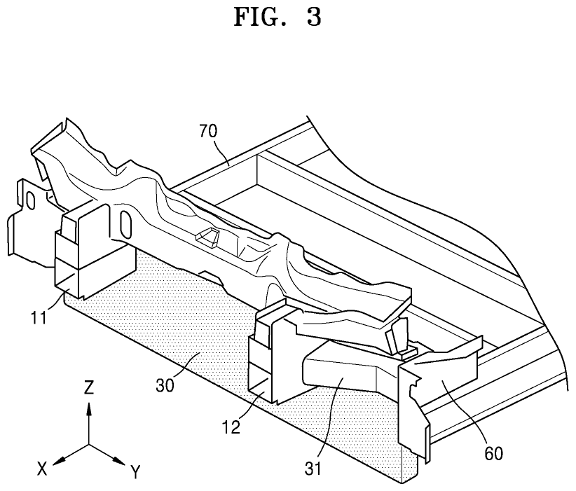

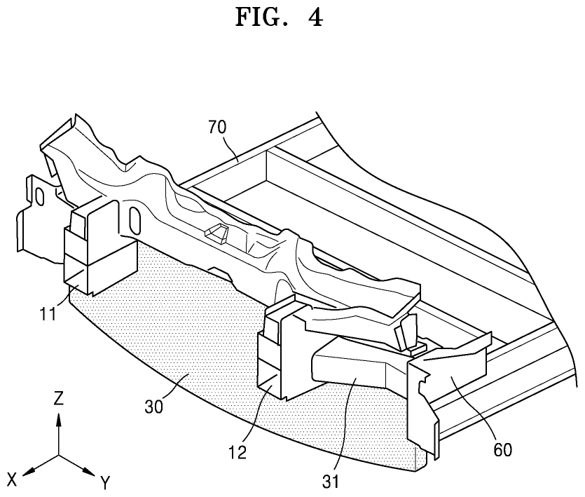

FIGS. 3 and 4 are perspective views schematically showing a rear cross member and a battery case, according to embodiments.

The battery case 70 and the battery may be arranged on an underside of the vehicle. Specifically, the battery case 70 and the battery may be arranged rearward of the rear cross member 30 and below the side sill inner front extension 60.

As described above, the rear cross member 30 may be connected to the first front side member 11 and the second front side member 12. The rear cross member 30 may extend in the transverse direction of the vehicle (for example, the y-direction).

The rear cross member 30 may overlap a front portion of the battery case 70 arranged rearward thereof. When viewed from the front side of the vehicle, the rear cross member 30 may cover the front portion of the battery case 70. When viewed from the front side of the vehicle, a front surface of the rear cross member 30 may have a rectangular shape to overlap the front surface of the battery case 70. However, the present disclosure is not limited thereto.

When viewed from the side of the vehicle, the side of the rear cross member 30 may have a rectangular shape. However, the present disclosure is not limited thereto. When viewed from the side of the vehicle, the side of the rear cross member 30 may have a parallelogram or trapezoid shape.

The rear cross member 30 may be arranged further toward a lower side of the vehicle than the battery case 70. Specifically, the rear cross member 30 may be arranged further toward the lower side of the vehicle than the battery case 70 by at least about 5% of a length of the battery case 70 in the vertical direction (e.g., the z-direction) of the vehicle.

As the rear cross member 30 may overlap the front portion of the battery case 70 and may be arranged further toward the lower side of the vehicle than the battery case 70, the rear cross member 30 may come into contact with an object before the battery case 70 when the object or a curb passes below the vehicle, the vehicle may come to a stop, and the battery case 70 and the battery, arranged in the rear portion of the rear cross member 30, may be prevented from being damaged.

In an embodiment, the rear cross member 30 may be provided in a straight shape. However, the present disclosure is not limited thereto.

In another embodiment, at least a portion of the rear cross member 30 may be provided in a curved shape. Specifically, at least a portion of the rear cross member 30 may be provided in a curved shape that is convex toward the front side of the vehicle. To be specific, a radius of curvature of the rear cross member 30 in the curved shape may be 1,500 mm or more.

When at least a portion of the rear cross member 30 is provided in a curved shape that is convex toward the front side of the vehicle, an object may collide with a convex portion of the rear cross member 30 when the object passes below the vehicle, allowing the vehicle body to deviate leftward and rightward and the vehicle to come to a stop or absorb energy in the event of the collision at the convex portion, such that the battery case 70 and the battery, arranged in the rear portion of the rear cross member 30, may be prevented from being damaged.

The rear cross member 30 may include a plated or non-plated cold-rolled steel material, and have a tensile strength of 780 MPa or greater. The rear cross member 30 may also include heat-treated steel, and have a tensile strength of 1470 MPa or greater. When the rear cross member 30 uses high-strength steel, the thickness of the rear cross member 30 in the longitudinal direction (e.g., the x-direction) of the vehicle may be reduced, thereby achieving weight reduction of the rear cross member 30.

According to embodiments of the present disclosure, the rear cross member 30 connecting the first front side member 11 to the second front side member 12 may overlap the front portion of the battery case 70. The rear cross member 30 may cover the battery case 70 such that when an object passes below the vehicle, the rear cross member 30 may collide with the object before the battery case 70, causing the vehicle to come to a stop and to absorb energy in the event of the collision, thereby preventing the battery case 70 and the battery from being damaged.

Although the present disclosure has been described with reference to an example shown in the drawings, it will be understood by those of ordinary skill in the art that various modifications and equivalent other examples may be made from the shown example. Accordingly, the true technical scope of the present disclosure should be defined by the technical spirit of the appended claims.

1. A vehicle body comprising:
a battery case on an underside of a vehicle;
a first front side member arranged on a front portion of the vehicle and extending in a longitudinal direction of the vehicle;
a second front side member spaced apart from the first front side member in a transverse direction of the vehicle and extending in the longitudinal direction of the vehicle; and
a rear cross member connecting the first front side member to the second front side member and extending in the transverse direction of the vehicle,
wherein the rear cross member is provided to overlap a front portion of the battery case.

2. The vehicle body of claim 1, wherein the rear cross member covers the front portion of the battery case when viewed from a front side of the vehicle.

3. The vehicle body of claim 1, wherein the rear cross member is arranged further toward a lower side of the vehicle than the battery case.

4. The vehicle body of claim 1, wherein the rear cross member is provided in a straight shape.

5. The vehicle body of claim 1, wherein at least a portion of the rear cross member is provided in a curved shape that is convex toward a front side of the vehicle.

6. The vehicle body of claim 1 further comprising a vehicle battery.

7. A vehicle comprising a vehicle body of claim 1.

8. A vehicle comprising a vehicle body of claim 6.

9. The vehicle of claim 7 wherein the vehicle is electric-powered.

10. The vehicle of claim 8 wherein the vehicle is electric-powered.
